(19) United States
(12) Patent Application Publication
(10) Pub. No.: US 2008/0030933 A1
(43) Pub. Date: Feb. 7, 2008

(54) KEYBOARD

(75) Inventors: RONG HU, Shenzhen (CN); XIAN-MING WANG, Shenzhen (CN); GUANG-DONG YUAN, Shenzhen (CN); CHUNG-CHI HUANG, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/615,012

(22) Filed: Dec. 22, 2006

(30) Foreign Application Priority Data
Aug. 4, 2006 (CN) 200610061979.9

(51) Int. Cl. G06F 1/16

(52) U.S. Cl. 361/680

(57) ABSTRACT

An exemplary keyboard includes a first keyboard unit having a container defined in a side thereof, and a second keyboard unit pivotally attached to the first keyboard unit. The second keyboard includes a handle to drive the second keyboard unit to rotate between a first position in which the second keyboard unit is accommodated in the container of the first keyboard unit, and a second position in which the second keyboard unit is outside the first keyboard unit.

### BACKGROUND OF THE INVENTION

1. Field of the Invention

The present invention relates to keyboards, and particularly to a reduced size keyboard.

2. Description of related art

Keyboards are used in a wide variety of electrical devices. Many arrays of keys have been developed for use, but the standard QWERTY remains the most popular. Keyboards are used in computers, phones and several other devices. A problem has arisen in keyboard technology where a relatively small keyboard is needed. Several approaches have been pursued in overcoming size reduction limitations imposed by the keyboard. First, many small devices, do not use an integrated keyboard and instead offer a very limited set of input means (e.g., a few keys, thumb pad, small touch screen, etc.). Devices of this sort do not allow the user to input text by typing. Second, miniature keyboards have been incorporated into handheld devices, providing the user with a full set of keys based on a standardized layout. The primary drawback of such miniature keyboards is that the user, while holding the device in both hands, types using only their thumbs, thereby eliminating the possibility of touch typing. Although the related art devices allow a reduction in keyboard size, they also reduce typing efficiency by preventing the user from utilizing standard touch typing skills.

Accordingly, what is needed in the art is a reduced size keyboard allowing efficient typing.

### SUMMARY OF THE INVENTION

An exemplary keyboard includes a first keyboard unit having a container defined in a side thereof, and a second keyboard unit pivotally attached to the first keyboard unit. The second keyboard includes a handle to drive the second keyboard unit to rotate between a first position in which the second keyboard unit is accommodated in the container of the first keyboard unit, and a second position in which the second keyboard unit is outside the first keyboard unit.

Other advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a keyboard in accordance with a preferred embodiment of the present invention;

FIG. 2 is an isometric view of the keyboard of FIG. 1 fully assembled, but showing a numeric keyboard in an operating position; and

FIG. 3 is similar to FIG. 2 showing the numeric keyboard in a non-operating position.

### DETAILED DESCRIPTION OF THE INVENTION

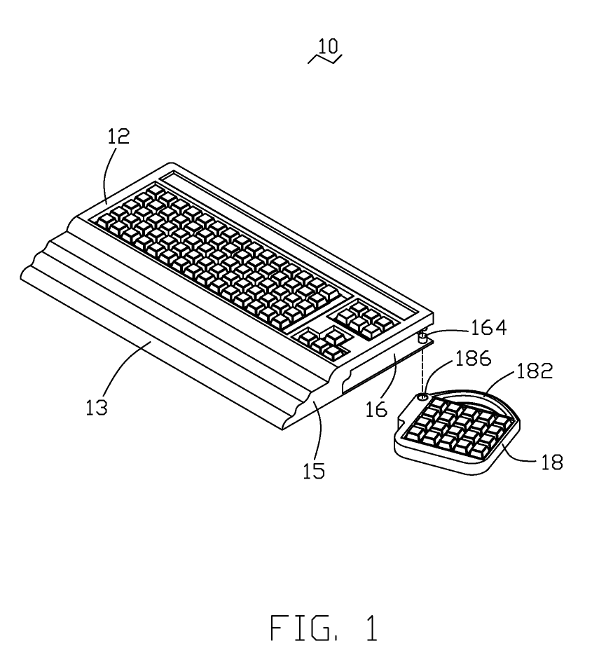

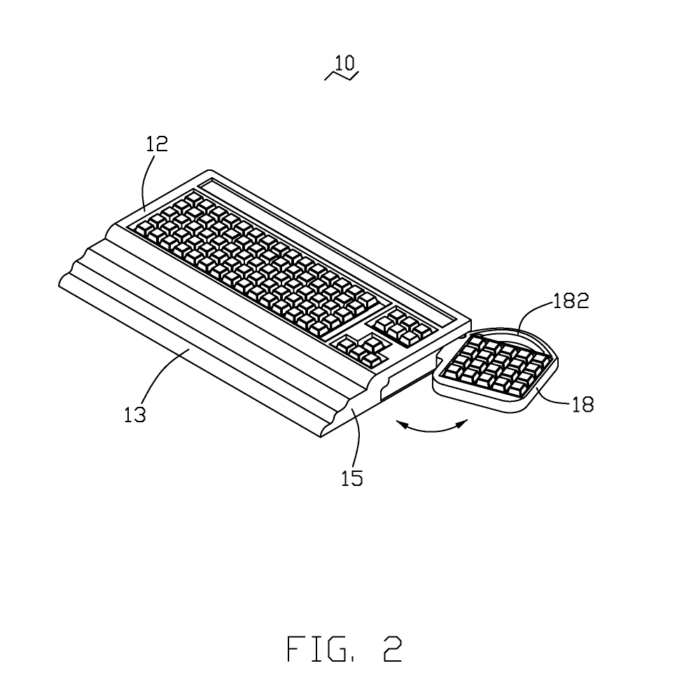

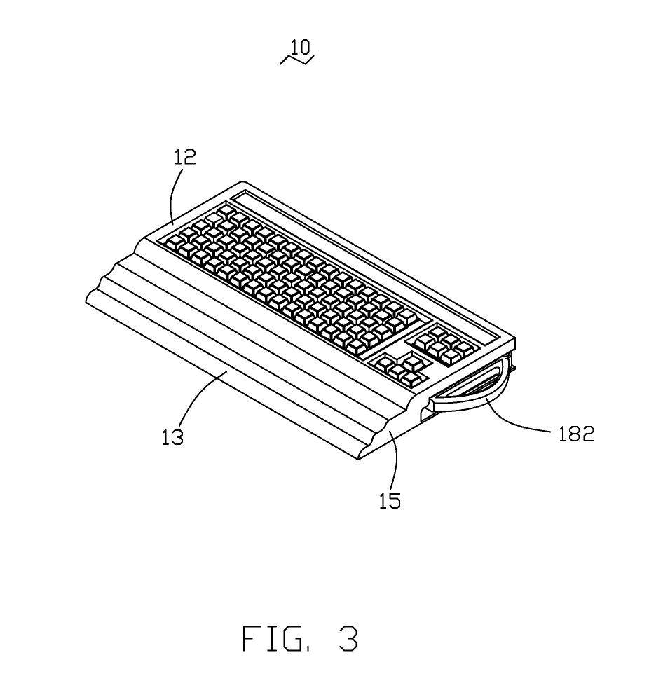

Referring to FIGS. 1 to 3, a keyboard 10 in accordance with a preferred embodiment of the present invention includes a main body 12, and a numeric keyboard 1 8.

The main body 12 is an alphabetic keyboard which has a plurality of keys and corresponding indicia including keys associated with alphabetic characters corresponding to a QWERTY array. The main body 12 has a rectangular configure with two longitudinal sides 15 and two latitudinal sides 13 longer than the longitudinal sides 15. The main body 12 includes a container 16 defined in a longitudinal side 15 thereof to accommodate the numeric keyboard 18 therein, and a shaft 164 is formed on the container 16 near an entrance of the container 16. The numeric keyboard 18 has an arcuate handle 182 integrally formed at a side thereof, and a through hole 186 is defined in the numeric keyboard 18 close to the handle 182 for insertion of the shaft 164 thereinto.

In assembly, the shaft 164 of the main body 12 is inserted into the through hole 186 of the numeric keyboard 18 to mount the numeric keyboard 18 to the main body 12. When the numeric keyboard 18 is not in use, the numeric keyboard 18 may be kept in a non-operating position where the numeric keyboard 18 is snugly housed in the container 16 with the handle 182 protruding from the side of the main body 12. When the numeric keyboard 18 is to be used, the handle 182 is rotated to drive the numeric keyboard 18 to pivot around the shaft 164 to an operating position where the numeric keyboard 18 is adjacent to the latitudinal side 13 of the main body 12, and keys on the numeric keyboard 18 are exposed from the container 16, then users can utilize standard touch typing skills to enter data.

According to the keyboard of the preferred embodiment of the invention, as described above, the numeric keyboard 18 is pivotably supported by the main body 12 and pivots about the shaft 164 between a non-operation position and an operation position. The keyboard of the preferred embodiment of the present invention is smaller than traditional keyboards and allows efficient typing.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A keyboard comprising:
a first keyboard unit having a container defined in a side thereof; and
a second keyboard unit pivotally attached to the first keyboard unit, the second keyboard unit comprising a handle to drive the second keyboard unit to rotate between a first position in which the second keyboard unit is accommodated in the container of the first keyboard unit, and a second position in which the second keyboard unit is outside the first keyboard unit.

2. The keyboard as claimed in claim 1, wherein the handle is formed at a side of the second keyboard unit.

3. The keyboard as claimed in claim 2, wherein a shaft is formed on the container adjacent an entrance of the container, a through hole is defined in the second keyboard unit close to the handle for receiving the shaft thereinto.

4. The keyboard as claimed in claim 1, wherein the first keyboard unit is an alphabetic keyboard, which has a plurality of keys and corresponding indicia including keys associated with alphabetic characters corresponding to a QWERTY array, and the second keyboard unit is a numeric keyboard.

5. A keyboard comprising:
a first keyboard unit with a plurality of keys defining an opening in one side thereof;
a second keyboard unit with a plurality of keys; and
a pivot structure formed between the first and second keyboard units and configured in such a manner that the second keyboard unit is pivotable with respect to the first keyboard unit between a first position where the second keyboard unit is received within the opening and a second position where the second keyboard unit is removed from the opening.

6. The keyboard as claimed in claim 5, wherein the first keyboard unit has a rectangular configure with two longitudinal sides and two latitudinal sides longer than the longitudinal sides, the second keyboard unit being adjacent to one of the latitudinal sides of the first keyboard unit at the second position.

7. The keyboard as claimed in claim 6, wherein the second keyboard unit comprises a handle integrally extending therefrom configured for driving the second keyboard to pivot with respect to the first keyboard unit.

8. The keyboard as claimed in claim 7, wherein the handle has an arcuate shape.

9. The keyboard as claimed in claim 7, wherein the handle is located outside of the opening and is adjacent to said one of the latitudinal sides of the first keyboard unit when the second keyboard unit is at the second position.

10. The keyboard as claimed in claim 5, wherein the pivot structure comprises a hole defined in one of the first and second keyboards and a shaft extending from the other one of the first and second keyboards and pivotably inserted in the hole.
